(19) United States
(12) Patent Application Publication
(10) Pub. No.: US 2024/0339242 A1
(43) Pub. Date: Oct. 10, 2024

(54) GRAPHENE BUSBAR

(71) Applicant: Mintsoft, LLC, Newport Beach, CA (US)

(72) Inventor: Jason Andrew Mindte, Newport Beach, CA (US)

(21) Appl. No.: 18/297,397

(22) Filed: Apr. 7, 2023

(51) Int. Cl. H01B 7/00; H01B 1/04; H01B 13/00; H01B 13/06; H01M 50/526

(52) U.S. Cl. CPC H01B 7/0009; H01B 1/04; H01B 13/0036; H01B 13/06; H01M 50/526

(57) ABSTRACT

A graphene busbar includes a graphene core formed by compressing graphene powder at high pressure. The busbar is insulated with an insulating and reinforcing material, which may be applied to the graphene core before or after compression. The busbar may also include contacts formed of an electrically conductive material, such as copper, that are connected to the graphene core.

### FIELD OF THE DISCLOSURE

The present disclosure is related to a graphene article for transmitting and/or distributing. More particularly, the disclosure relates to a compressed graphene material for use in a busbar as well as methods of making the same.

### BACKGROUND

Busbars are used for electric power distribution and generally consist of a conductive metallic bar or strip. Common conductive metals include copper, brass, or aluminum. However, these materials are often heavy, which increases installation and transportation costs. They also suffer from resistive losses. As such, there remains a need for a lightweight, highly conductive material for electric power distribution.

### BRIEF DESCRIPTION OF THE FIGURES

Various embodiments of the present disclosure will be understood more fully from the detailed description given below and from the accompanying drawings. In the drawings, like reference numbers may indicate identical or functionally similar elements. Embodiments are described in detail hereinafter with reference to the accompanying figures, in which:

FIG. 1 is a perspective view of a busbar according to an embodiment of the present disclosure.

FIG. 2A is a side view of the busbar of FIG. 1.

FIG. 2B is a cross-sectional view of the busbar of FIG. 2A along the line A-A.

FIG. 3A is a top view of the busbar of FIG. 1.

FIG. 3B is a cross-section view of the busbar of FIG. 3A along the line B-B.

FIG. 4A is a side view of a contact according to an embodiment of the present disclosure.

FIG. 4B is a top view of the contact of FIG. 4A.

### DETAILED DESCRIPTION

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

Graphene is a single layer (monolayer) sheet of carbon atoms that are bonded together in a repeating pattern of hexagons. The extraordinary characteristics of graphene originate from the 2p orbitals, which form the π state bands that delocalize over the sheet of carbons that constitute graphene. Graphene is harder than diamond but more elastic than rubber. It is tougher than steel yet lighter than aluminum. Graphene is one of the strongest known materials.

The unique structure of graphene gives it an electron mobility about 100× faster than silicon. Graphene conducts heat 2× better than diamond and its electrical conductivity is 13× better than copper. Graphene absorbs only 2.3% of reflecting light and is so impervious that even the smallest atom (helium) cannot pass through a defect-free monolayer graphene sheet. Graphene has a high surface area of 2,630 square meters per gram. Graphene is also highly recyclable and may be produced from organic waste.

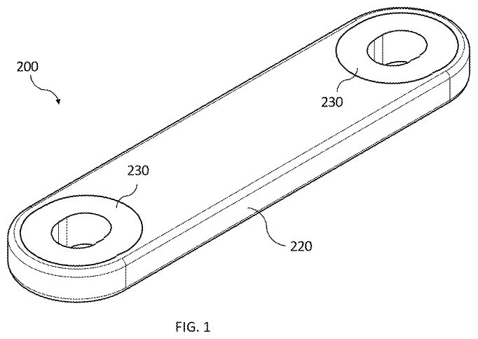

With reference to FIG. 1, the graphene busbar 200 according to embodiments of the present disclosure may include a reinforcement layer 220 disposed on an outer surface thereof. In some embodiments, the reinforcement layer 220 may include fiberglass, such as a fiberglass composite. In some embodiments, the reinforcement layer 220 includes an electrically insulating material, such as poly (vinylidene fluoride), poly (vinylpyrrolidone), or combinations thereof. In some embodiments, the reinforcement layer has a thickness of about 5 mm, about 1 to 10 mm, about 2 to 7 mm, or about 4 to 6 mm.

In some embodiments, a separate insulating layer (not shown) may be included under the reinforcement layer 220. In such embodiments, the insulating layer has a thickness of about 5 mm, about 1 to 10 mm, about 2 to 7 mm, or about 4 to 6 mm.

In some embodiments, the busbar 200 includes one or more contacts 230 for connecting the busbar 200 to other electrical components, such as battery banks. The contacts 230 are formed of an electrically conductive material. In some embodiments, the contacts 230 are formed of graphene. In other embodiments, the contacts 230 are formed of copper, optionally including a surface coating such as silver plating to prevent oxidation.

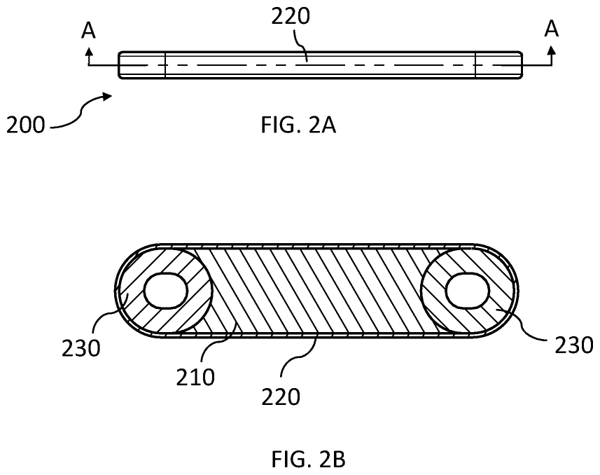

Turning to FIG. 2A, a side view of the busbar 200. FIG. 2B is a cross-sectional view taken along the line A-A in FIG. 2A. In FIG. 2B, the graphene core 210 is shown, encased in the reinforcement layer 220. The graphene core 210 may be formed of compressed graphene powder. In some embodiments, the graphene powder comprises at least 95 wt %, at least 97 wt %, or at least 99 wt % C12 carbon, with a remainder comprising C13 and/or other carbon isotopes. In some embodiments, the graphene powder is compressed at a pressure of at least 800 tons per square inch, at least 1,000 tons per square inch, at least 1,500 tons per square inch, at least 2,000 tons per square inch, at least 4,000 tons per square inch, at least 6,000 tons per square inch, at least 8,000 tons per square inch, or 800 to 8,000 tons per square inch or any range therewithin. A press mold may be used to form the graphene powder into the elongated shape of the graphene core 210. In some embodiments, the graphene core 210 has a thickness of greater than 0″ to 2″, 0.1″ to 1.5″, or 0.5″ to 1″. In some embodiments the reinforcement layer 220 is applied to the graphene core 210 after it is formed. In other embodiments, the reinforcement layer 220 may be formed by wrapping graphene powder in a reinforcement material comprising fiberglass, poly (vinylidene fluoride), poly (vinylpyrrolidone), or combinations thereof and then compressing the entire assembly at the pressures noted above. In any embodiments, the contacts 230 may be installed after compression or may be positioned within the graphene powder prior to compression.

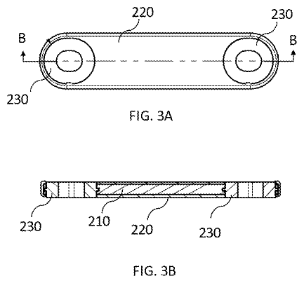

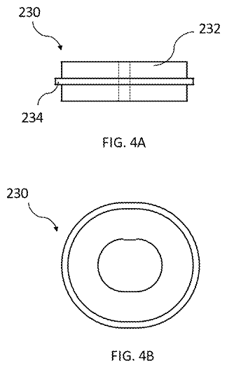

Next, FIG. 3A is a top view of the busbar 200 and FIG. 3B is a cross-sectional view taken along the line B-B in FIG. 3A. In FIG. 3B, it is again seen that the graphene core 210 is surrounded by the reinforcement layer 220 and in electrical contact with the contacts 230.

Turning to FIG. 3A, the contact 230 is shown separate from the busbar 200. In some embodiments as shown, the contact 230 may include a cylindrical body 232 and a protruding ring 234 to increase surface area for contacting the graphene core 210. FIG. 3B depicts a top view of the contact 230.

In some embodiments, the graphene busbar 200 is electrically connected to a battery bank to facilitate distribution of power between elements thereof. In some embodiments, a plurality of busbars 200 may be connected to the battery bank.

In some embodiments, the busbar 200 may be configured to handle up to 10,000 volts and 2,000, 5,000, or 10,000 amps. According to some embodiments of the present disclosure, the graphene busbar 200 has near zero resistance and is capable of handling 10,000 amps and 10,000 volts at the same time. The busbar 200 also has a loss rate of 0.0012-0.002, making it 99.8-99.88% energy efficient. The graphene core 210 weighs 70 times less than steel, yet has three times the tensile strength of steel. It is also fireproof, bullet proof, and may have a lifespan of 100 year or longer.

Many of the benefits of the graphene busbar 200 disclosed herein are due to the atomic properties of graphene. Using the synchronization principle, an atomic unit moves in oscillations with the next in the same frequency. This continues down the line until electricity reaches another point. The atomic weight impacts the speed of oscillations. Larger/heavier atomic sizes have a different vibration and a slower lag time. Copper has a larger mass (63.546 g/mol) than graphene (12.1 g/mol). Using graphene results in much more consistent performance and no resistance, resulting in 99.999% efficiency. The atomic weight of lithium iron phosphate is 115, making the benefits of graphene over this material even greater. Further, metals, including copper, contain elements or neutrons that cause resistance. As such, the graphene busbar 200 is capable of distributing energy more quickly and efficiently than is currently possible.

Although various embodiments have been shown and described, the disclosure is not limited to such embodiments and will be understood to include all modifications and variations as would be apparent to one of ordinary skill in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

What is claimed is:

1. A busbar comprising:
an elongated core formed of graphene;
an outer layer covering the elongated core, the outer layer being formed of an electrically insulating material.

2. The busbar of claim 1, further comprising an electrically conductive contact electrically connected to the elongated core.

3. The busbar of claim 2, wherein the contact is formed of copper.

4. The busbar of claim 3, wherein the contact is silver plated.

5. The busbar of claim 1, wherein the outer layer comprises fiberglass.

6. The busbar of claim 1, wherein the outer layer comprises poly (vinylidene fluoride), poly (vinylpyrrolidone), or a combination thereof.

7. The busbar of claim 1, wherein the graphene core is formed of graphene powder compressed at a pressure of at least 800 tons per square inch.

8. A method comprising:
compressing graphene powder at a pressure of at least 800 tons per square inch to form an elongated core; and
insulating the elongated core with an insulating material.

9. The method of claim 8, wherein compressing is performed at a pressure of at least 2000 tons per square inch.

10. The method of claim 9, wherein, during compressing, an electrical charge is applied to the graphene powder.

11. The method of claim 8, wherein insulating the elongated core comprises wrapping the graphene powder with the insulating material prior to compressing.

12. The method of claim 8, wherein the insulating material comprises fiberglass, poly (vinylidene fluoride), poly (vinylpyrrolidone), or a combination thereof.

13. The method of claim 8, further comprising connecting electrically conductive contacts to the elongated core.

14. The method of claim 13, wherein connecting the electrically conductive contacts comprises positioning the contacts within the graphene powder prior to compression.

15. The method of claim 14, wherein the contacts comprise copper.

16. The method of claim 15, wherein the copper is silver plated.

17. A battery bank comprising:
a plurality of batteries;
at least one busbar according to claim 1 in electrical contact with the plurality of batteries.
